(19) United States
(12) Patent Application Publication
(10) Pub. No.: US 2009/0058812 A1
(43) Pub. Date: Mar. 5, 2009

(54) MOBILE COMPUTING DEVICE CONSTRUCTION USING FRONT PANELED ASSEMBLY AND COMPONENTS THEREOF

(76) Inventors: Yoshimichi Matsuoka, Cupertino, CA (US); Kevin Lee, Hillsborough, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 11/848,184

(22) Filed: Aug. 30, 2007

(51) Int. Cl. G06F 3/02

(52) U.S. Cl. 345/169

(57) ABSTRACT

A computing device includes a processor, a display component, a keypad assembly and a panel. The display component includes a display area that is pressure-sensitive to detect user-contact with the device over the display area. The display component is coupled to signal the processor when contact is detected. The keypad assembly includes a plurality of key structures. Each of the key structures is aligned over a corresponding contact element provided on an electrical contact layer. Each key structure is pressable, and the corresponding contact element of each key structure is triggerable with contact to signal the processor. The panel is provided over the display area to extend between the key structures and the electrical contact layer. The panel is structured so that, when the computing device is operational, (i) a user contact with a region of the panel that overlies the display area is detectable by the display component to signal the processor, and (ii) pressure on any key structure is sufficient to move at least a portion of the panel inward into the corresponding contact element in order to trigger the contact element into signaling the processor.

### TECHNICAL FIELD

The disclosed embodiments relate generally to the field of mobile computing devices. In particular, the disclosed embodiments pertain to a construction of a frontal face and assembly of a mobile computing device.

### BACKGROUND

Over the last several years, the growth of cell phones and messaging devices has increased the need for keypads and button/key sets that are small and tightly spaced. In particular, small form-factor keyboards, including QWERTY layouts, have become smaller and more tightly spaced. With decreasing overall size, there has been greater focus on efforts to provide functionality and input mechanisms more effectively on the housings.

In addition to a keyboard, mobile computing devices and other electronic devices typically incorporate numerous buttons to perform specific functions. These buttons may be dedicated to launching applications, short cuts, or special tasks such as answering or dropping phone calls. The configuration, orientation and positioning of such buttons is often a matter of concern, particularly when devices are smaller.

At the same time, there has been added focus to how displays are presented, particularly with the increase resolution and power made available under improved technology. Moreover, form factor consideration such as slimness and appearance are important in marketing a device.

### BRIEF DESCRIPTION OF THE DRAWINGS

FIG. 1 is a representative side view of a mobile computing device constructed in accordance with an embodiment of the invention.

FIG. 2A is a side view of a display component for providing display area 120, under an embodiment of the invention.

FIG. 2B is a side view of an alternative display component for providing the display area 120, under another embodiment of the invention.

FIG. 3A illustrates a key structure layer for use in a keypad region, such as provided with the front face 102 of device 100 in FIG. 1.

FIG. 3B illustrates the electrical contact layer 334 that underlies the panel 150, according to an embodiment such as shown by FIG. 1.

FIG. 4 illustrates the panel 150 used for frontal assembly 110, according to an embodiment of the invention.

FIG. 5 is a representative side view of a mobile computing device having an alternative construction in which a modular keypad component is used, according to an embodiment of the invention.

FIG. 6 is an exploded isometric view of a mobile computing device incorporating features of one or more embodiments described herein.

### DETAILED DESCRIPTION

Embodiments described herein provide for a mobile computing device constructed to include a panel on which a display area and a keypad are made available. In an embodiment, the display area may be provided flush on the panel. Still further, an embodiment provides that the keypad assembly is molded or integrally formed onto the panel at another region. One result provided by an embodiment is relatively smooth and unifying front face for a mobile computing device, having a substantially flush display area and an integrally formed keypad.

Among other advantages, embodiments recognize that components such as keypads (or keyboards) and display components are increasingly manufactured by different sources and then assembled into one device. Tolerances resulting from the use and combination of different devices may conflict with the acceptable tolerance needed to assemble the device. Moreover, quality control issues arise to design and appearance of prominent exterior features, such as those provided with keypads, displays and the front façade.

Accordingly, one or more embodiments provide for a front assembly that includes a panel that extends to encompass at least a substantial portion of the front face. In one embodiment, the panel overlays the display, while providing a surface on which a keypad or keyboard may be formed. The result is that a large portion of the front face may be made flush are bevel-less, without affect from possible conflicting tolerances that would otherwise result if no such panel existed. The panel that overlays the display component masks any deficiencies in the construction and/or assembly of the display component. By extending the panel to underlie the key structures, one or more embodiments further enable a single source of manufacturing to control the implementation and appearance of both the keypad and display on a front face of the computing device.

In an embodiment, a computing device includes a processor, a display component, a keypad assembly and a panel. The display component includes a display area that is pressure-sensitive to detect user-contact with the device over the display area. The display component is coupled to signal the processor when contact is detected. The keypad assembly includes a plurality of key structures. Each of the key structures is aligned over a corresponding contact element provided on an electrical contact layer. Each key structure is pressable, and the corresponding contact element of each key structure is triggerable with contact to signal the processor. The panel is provided over the display area to extend between the key structures and the electrical contact layer. The panel is structured so that, when the computing device is operational, (i) a user contact with a region of the panel that overlies the display area is detectable by the display component to signal the processor, and (ii) pressure on any key structure is sufficient to move at least a portion of the panel inward into the corresponding contact element in order to trigger the contact element into signaling the processor.

According to another embodiment, a computing device includes a processor, a display component, a keypad assembly and a panel. The display component provides or includes a display area. The keypad assembly includes a plurality of key structures. Each of the key structures may be aligned over a corresponding contact element provided on an electrical contact layer. Each key structure is pressable, and the corresponding contact element of each key structure is triggerable with contact to signal the processor. The panel may be provided over the display area to extend between the key structures and the electrical contact layer. The panel may include at least a translucent window that overlays the display area and is structured so that inward movement of any key structure is sufficient to move at least a portion of the panel inward into the corresponding contact element.

Still further, one or more embodiments provide for a frontal assembly for a mobile computing device. The fontal assembly includes a display component, a keypad assembly, and a panel. The display component includes or provides a display area. The keypad assembly includes a plurality of key structures, and each of the key structures is aligned over a corresponding contact element provided on an underlying electrical contact layer. Each key structure is pressable. The panel may provided over the display area to extend between the key structures and the electrical contact layer. The panel is structured to be in contact with the display area and with the plurality of key structures, so that movement of any key structure is sufficient to move at least a portion of the panel inward into the corresponding contact element.

As used herein, the term “modular” means a pre-assembled or pre-manufactured component. A modular component, for example, means a component that is manufactured and used as one piece in a larger assembly.

Furthermore, the term “substantially flush” means flushness between two surfaces to a degree that appears flush to casual viewing by an observer. For example, two surfaces that are flush within tolerance levels of manufacturing may be said to be “substantially flush”.

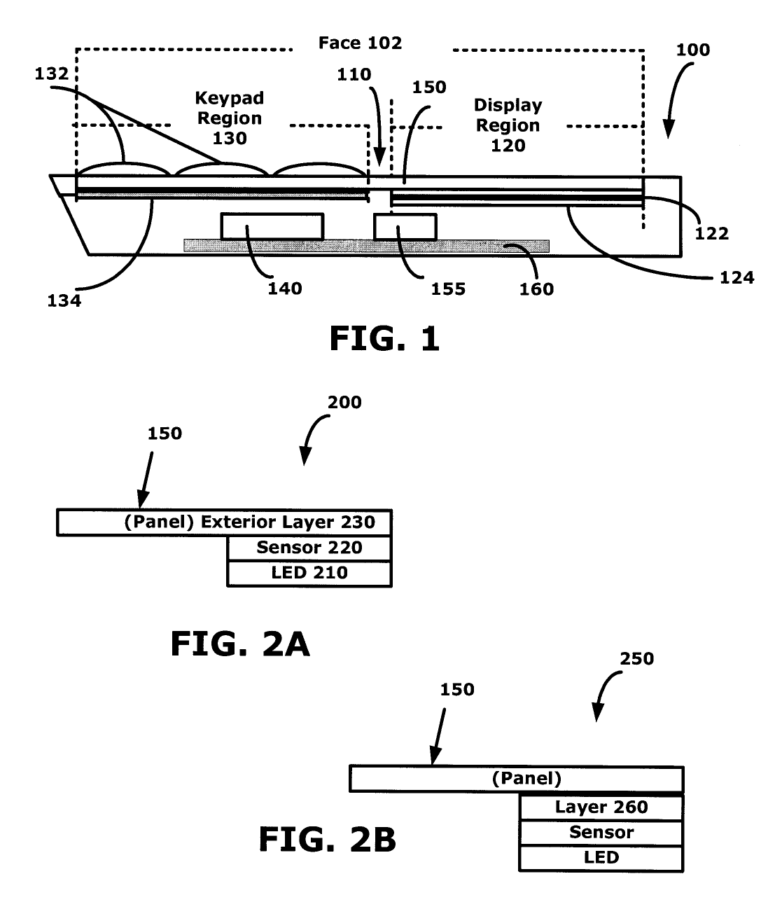

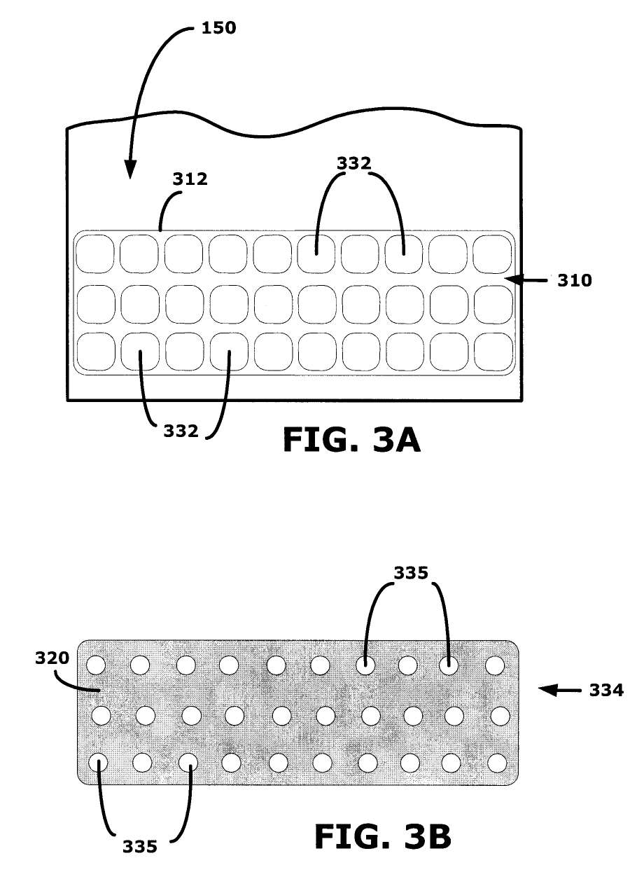

FIG. 1 is a representative side view of a mobile computing device constructed in accordance with an embodiment of the invention. In an embodiment, a mobile computing device 100 includes a frontal assembly 110 that provides a front face 102 for the device 100. In an embodiment, the front face 102 includes a display area 120 and a keypad region 130. The display area 120 may correspond to a surface provided by a display component such as described with an embodiment of FIG. 2A and FIG. 2B. The keypad region 130 may correspond to a section of the front face 102 on which a keypad, such as a keyboard and/or number pad, is provided. Examples of different types of keypads that may be used to provide the keypad region 130 are described with embodiments of FIG. 3A, FIG. 3B and FIG. 5. As will be described in more detail, one or more embodiments provide that the frontal assembly 110 includes a panel 150 that extends over the display region 120 and under the keypad area 130.

Other features and regions may also be provided on the front face 102. For example, a button set (not shown in FIG. 1) to control use and launch of software and software features, as well as enable navigation, may be provided between the display area 120 and the keypad region 130.

The mobile computing device 100 may include various internal components, including processor 140 and memory 155 provided on a printed circuit board 160. The processor 140 may generate data that is displayed as content on the display area 120, and detect and interpret input made through user-interaction with both the keypad region 130 and the display area 120. Components such as analog-digital converters may be used to process signals from display region and/or keypad assembly 130. For simplicity, such additional components are not shown.

The display region 120 may be provided by a display component. In one embodiment, the display component is provided by a combination of a Liquid Crystal Display (LCD) 122 and contact-sensors 124. The contact-sensors 124 may correspond to, for example, resistive sensors that detect pressure from contact. The processor 140 may detect and interpret contact made with the LCD 122 through signals generated from the contact-sensors. As mentioned, additional signal handling components, such as analog-digital converters, may also be used. The panel 150 may be placed to provide an added exterior thickness to the display region 120.

In an embodiment, the keypad region 130 is provided by a keypad assembly that has anyone of many forms. According to one embodiment, the keypad assembly is made operational with multiple layers, and the layers are separated by the panel 150. An exterior layer may provide the keypad region 130, comprising a thickness that defines plurality of key structures 132. The layer of the key structures 132 may operate in connection with an electrical contact layer 134 that underlies the panel 150 and the plurality of key structures 132. The electrical contact layer 134 may include contacts 335 (FIG. 3B) that are actuatable with contact or sufficient force. The panel 150 may be attached to an underlying surface of the keypad structures 132 and to a top surface of the electrical contact layer 134.

The panel 150 may have the form of a hard coat surface. As such, panel 150 provides a protective exterior for the display component. In one embodiment, the panel 150 is formed from polyethylene terephthalate (PET) film. More generally, the panel 150 may be formed from a material such as plastic. While the panel 150 may provide a protective hard coat, panel 150 may also be sufficiently thin so that inward pressure from one of the key structures 132 translates pressure through the panel 150 and onto the underlying electrical contact element 335 (FIG. 3) for that structure. In one implementation, each key structure 132 is aligned to include its own electrical contact element 335, although other implementations provide that one electrical contact may be shared with different key structures.

Among other benefits, an embodiment such as described with FIG. 1 enables device 100 to have a display region 120 that is bevel-less. More particularly, the display region 120 may be substantially flush with adjacent regions of the front face 102 that are not part of the display region 120. Such a substantially flush transition protects the display component from, for example debris, while at the same time providing a more pleasing design. Additionally, the key structures 132 (or the layer thereof) may be formed directly on the panel 150, simplifying construction and/or assembly of the device 100 as a whole. The panel 150 may also be provided with various design elements that include graphics for individual key structures.

While FIG. 1 is illustrative, the thicknesses shown of various components are not to scale or proportion. In one implementation, the approximate thickness of panel 150 is in the range of 0.1 to 0.3 mm, and more particularly at about 0.2 mm.

FIG. 2A is a side view of a display component for providing display area 120, under an embodiment of the invention. A display component 200 may include multiple thicknesses, generally including an LCD layer 210 and a sensor layer 220. In some alternative implementations, the sensor layer 220 and LCD layer 210 may occupy the same thickness. More layers may be provided, including an exterior protective coat 230. In one embodiment, the exterior protective coat 230 is provided by a portion of panel 150 that extends to support portions of the keyboard assembly 130 (not shown).

As an alternative or addition to an embodiment of FIG. 2A, the exterior protective coat 230 may be formed from a combination of a thin thickness and a rigid backing material. In one implementation, the thin thickness may be provided by a material such as a PET film. An example of an approximate dimension of the PET film is 0.2 mm. The rigid backing material may correspond to, for example, a polycarbonate material having an approximate thickness of about 1.0 mm. In one implementation, the polycarbonate material and the PET film combine at a region that overlays the display. The PET film extends to form the remainder of the panel 150 on which, for example, key structures or a keypad are formed.

The display component 200 may interconnect with the processor 140 and other internal sources of the device 100 (such as power). In order to display content, display component 200 may be coupled to a display driver (not shown) and other components that process the display instructions.

FIG. 2B is a side view of an alternative display component for providing the display area 120, under another embodiment of the invention. In an embodiment of FIG. 2B, the display component is modular, such as an over-the-shelf component. The display component 250 includes multiple thicknesses, including an external hard coat display thickness 260. According to an embodiment, the panel 150 is mounted over the external display thickness 260, so as to provide a second hard-coat layer.

While embodiments illustrated with FIG. 1 and FIG. 2A and FIG. 2B provide for a contact-sensitive display, one or more embodiments described herein provide for a construction in which the mobile computing device 100 includes a non-contact-sensitive display. Under such an embodiment, the display component 200 does not, incorporate the use of the sensor.

FIG. 3A illustrates a key structure layer for use in a keypad region, such as provided with the front face 102 of device 100 in FIG. 1. Under an embodiment such as shown with FIG. 3A, a plurality of key structures 132 (FIG. 1) are provided by a portion of key structure layer 310 that includes formed or shaped key caps 332. With further reference to an embodiment of FIG. 1, the single piece structure 310 overlays a portion of the panel 150 defined by the keypad region 130. The plurality of key structures 132 may be joined by a carrier 312 that extends between formations corresponding to individual key structures. The carrier 312 may correspond to a base or web layer that interconnects some or all of the key structures. The key structure layer 310 may be formed from resin, plastic or other material. In one embodiment, the key structure layer is translucent, so as to make visible any markings or decorative elements provided on the underlying panel 150.

According to an embodiment, the key structures 132 are pressable in that they deform or squish when pushed. As an alternative or addition, however, the key structures 132 may move or travel inward when pressed.

FIG. 3B illustrates the electrical contact layer 334 that underlies the panel 150, according to an embodiment such as shown by FIG. 1. An electrical contact layer 334 such as shown in FIG. 3B may be used in connection with the key structure layer 310 to provide a keypad of the keypad region 130 (FIG. 1). In one embodiment, the electrical contact layer 334 corresponds to a printed circuit board 320 having electrical contact elements 335. The electrical contact elements 335 may be in the form of electrical leads, snap dome switches or, for example, other elements that form “switches” having open and closed states. In one implementation, one electrical contact element 335 is aligned under each key structure caps (FIG. 3A) of the key structure layer 310 (FIG. 3A).

As mentioned with FIG. 1, one or more embodiments provide that the panel 150 may extend between the key structure layer 310 of FIG. 3A and the electrical contact layer 334 of FIG. 3B. The panel 150 may be sufficiently thin to enable pressure applied to one of the key structures to translate into sufficient pressure or force to close the aligned electrical contact 335 (FIG. 3B). In an embodiment in which the key structures caps (FIG. 3A) deform, the deformation of any one key structure may provide the pressure onto the panel 150 that triggers the aligned contact element 335 (FIG. 3B) on the underlying PCB 320. In an embodiment in which the key caps 332 move inward, the inward movement of any one key structure may provide the pressure onto the panel 150 that triggers the corresponding aligned contact element 335.

In an embodiment, the plurality of key structures 132 (FIG. 1) is formed onto the panel 150 during a manufacturing process that results in the formation of key caps 332 and carrier 312. For example, injection molding design (IMD) or other molding techniques may be used to form key caps (as the key structures) directly on the panel 150, or alternatively onto a carrier that is formed on the panel 150. As an alternative, the plurality of key structures 132 may be provided by assembling or affixing the structure 310 (or the key caps 332) onto the panel 150. For example, adhesives may be used to affix the carrier 312 and/or individual key caps 332 onto the panel 150. In either case, one or more embodiments provide that panel 150 may be imprinted to carry some or all of the graphics provided with the key structures 132 (FIG. 1). For example, as described with one or more other embodiments, individual key structures may be provided with graphics that indicate an alphanumeric value or icon.

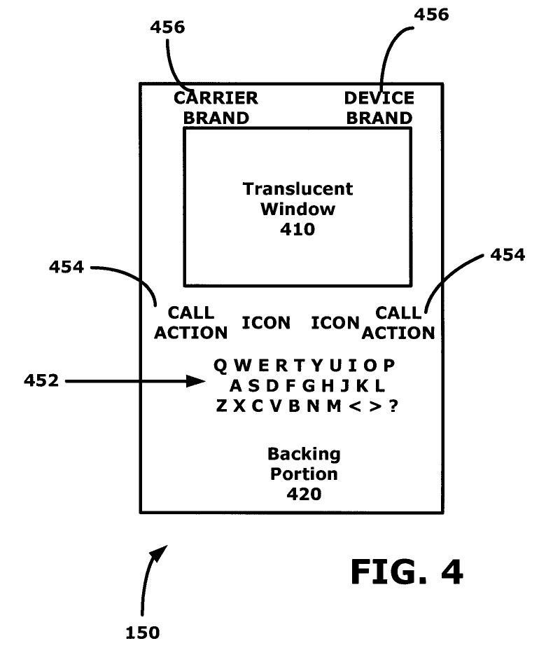

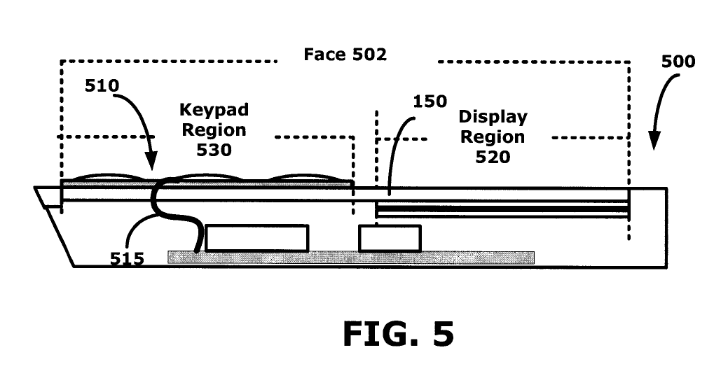

FIG. 4 illustrates the panel 150 used for frontal assembly 110, according to an embodiment of the invention. The panel 150 may be dimensioned to be substantially rectangular so as to extend at least a majority of the length of the front face. In an embodiment, the panel 150 includes a clear (or translucent) window 410 and a backing portion 420. The window 410 may be dimensioned to substantially match an area used by the display component 120, so that it can overlay the display component (such as shown with an embodiment of FIG. 2A or FIG. 2B) without occluding any part of the display region 120.

The backing portion 420 provides the surface on which the plurality of key structures 132 (FIG. 1) are formed or are otherwise provided. In an embodiment, the backing portion 420 of panel 150 may have imprints or graphics that form some or all of the key structure graphics. For example, a first set of graphics 452 may correspond to prints of letters and numbers in regions that are to underlay key structures 132 when the key structures are subsequently attached or formed on the panel. The graphics 452 may be positioned in regions that underlie corresponding key structures 132 that are to carry that value when the device is in use. In one implementation, some key structures carry letter values, number values or both. Furthermore, under one implementation, the graphics 452 may represent key structure values in a specific mode of operation of the device (e.g. default mode), as logic and/or software on the device may assign other values to individual key structures.

As an alternative or addition to graphics for a keypad, other graphics 454 may also be provided for a button (or key) set area of the device. For example, many types of mobile computing devices include a button set adjacent to the display area that includes navigation functionality, call action buttons (e.g. answer incoming call, hang-up), feature buttons for device or software control, and/or application launch buttons. Functionality associated with some or all of these buttons may be represented iconically, or otherwise through graphics. The set of graphics 454 may be imprinted onto panel 150 to provide such iconinc graphics for buttons of such a button set.

Other examples of graphics or imprints that may be provided on the panel 150 including branding graphics 456. In an embodiment in which the mobile computing device 100 uses cellular networks, the device may carry both a wireless carrier brand and a manufacturing or device brand. Other brands may also be carried, such as a brand for the operating system in use on the device.

FIG. 5 is a representative side view of a mobile computing device having an alternative construction in which a modular keypad component is used, according to an embodiment of the invention. On a device 500, a modular keypad component 510 may combine a layer of key structures and the electrical contact layer into one thickness that can be mounted onto the backing portion 420 (FIG. 4) of the panel 150.

One example of such a modular keypad is a “sheet key”, which is a pre-manufactured component. The modular keypad component 510 may provide a keyboard (e.g. having a QWERTY arrangement) with, for example, alternative numerical assignments to select keys in order to enable corresponding numeric input (e.g. such as to place phone calls). A flex cable 515 may interconnect the keypad component 510 to internal components of the device, including processing resources 140 and power (not shown).

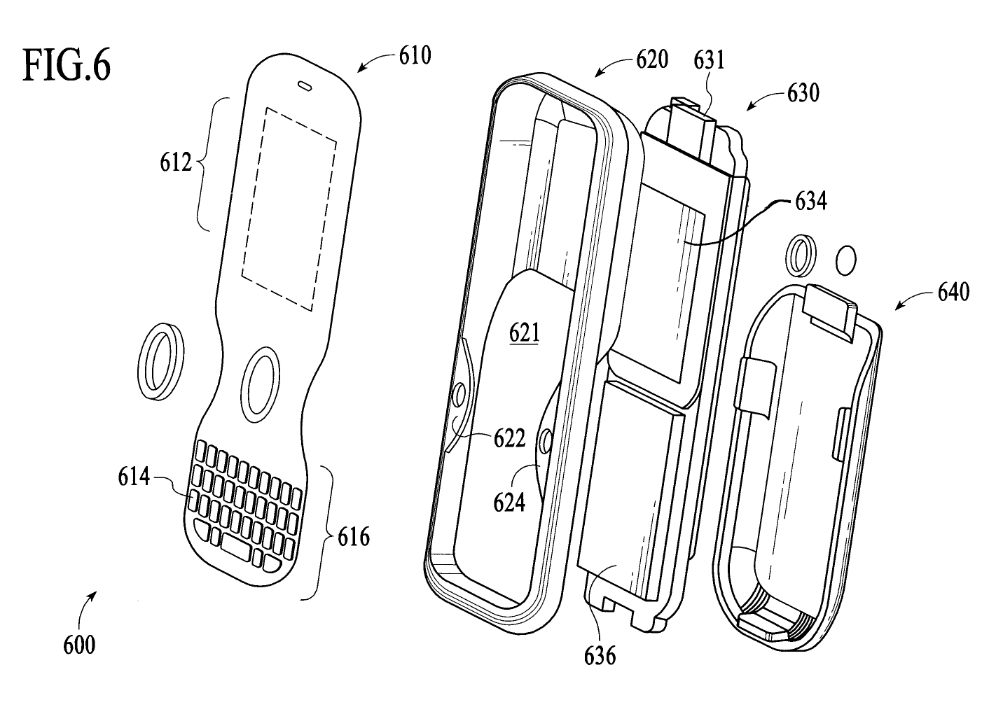

FIG. 6 is an exploded isometric view of a mobile computing device incorporating features of one or more embodiments described herein. A mobile computing device 600 includes a panel 610, housing structure 620, integrated board 630, and back panel 640. In one embodiment, the integrated board 630 includes a printed circuit board 632 with modularized display component 634 and electrical contact layer 636 for a keypad assembly. Numerous other internal components of device 600 may be included on integrated board 630, including processing resources (not shown), memory resources (not shown), power (e.g. from on-board battery or external connection), and wireless communication components. The wireless communication components may include both short range and long range components, including Bluetooth, cellular communications, Wireless Fidelity (or “WiFi”; i.e. 802.11(b) or 802.11(g)) communication components or Global Positioning System (GPS) devices.

An embodiment of FIG. 6 reduces the number of housing elements used to create a mobile computing device (e.g. cellular phone) housing as compared to conventional designs. For example, some conventional techniques use a midframe that joins a front panel and a back panel. Often, devices include a fourth component to provide a backing for the battery panel. In contrast, an embodiment of FIG. 6 uses one shaped housing to eliminate need for the front panel, back panel or midframe of conventional designs. The back panel 640 may act as a battery panel.

According to one embodiment, the integrated board 630 is modularized, so as to be pre-assembled and usable as one piece when assembling the device 600 as a whole. The integrated board 630 may be inserted into the housing structure 620. The housing structure 620 may include front and structural features 622, 624 that serve to retain the integrated board 630 in place. Fasteners, adhesives or other suitable components may also be used to retain the integrated board 630 in position.

The panel 610 may be placed over the integrated board 630 and within the housing structure 620. Unlike some other embodiments described, panel 610 is shaped to be non-rectangular, for purpose of design or style. Front structural features 622 may retain the panel 610 in position against the integrated board 630. A display region 612 of the panel 610 may overlap with the display component 634 provided on the integrated board 630. At least this portion of display region 612 may be clear or translucent so as to not occlude display component 634.

In one embodiment, a key structure layer 614 is molded, or otherwise formed or provided on a backing portion 616 of the panel 610. The key structure layer 614 overlaps with the electrical contact layer 636 on the integrated board 630. In one embodiment, the key structure layer 614 may include deformable key elements that enable a user to apply discrete pressure to panel 610, which translates into contact and actuation of individual contact elements on the electrical contact layer 636.

As shown by an embodiment of FIG. 6, the display region 612 may be substantially flush with surrounding non-display regions of the panel 610. This enables the panel 610 to provide a relatively smooth and flat front face for the device 600, without need for sunken or beveled display regions. Moreover, as described elsewhere, the key structure layer 614 may be formed on a corresponding region of the panel 610.

According to an embodiment, in order to assemble the device 600, one or more embodiments provide for the following steps to be performed: (i) insertion of the integrated board 630 into the housing structure 620, with the direction of insertion being a top edge 631 of the board being moved into a bottom open region 621 of the housing structure; (ii) placement of the panel 610 over the integrated board 630; and (iii) securement (via compression) of the back panel 640 against the housing structure 620. Additional features, such as a navigation ring may be provided at any time.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

1. A computing device comprising:
a processor;
a display component having a display area, the display area being pressure-sensitive to detect user-contact with the device over the display area, the display component being coupled to signal the processor when contact is detected;
a keypad assembly comprising a plurality of key structures, each of the key structures being aligned over a corresponding contact element provided on an electrical contact layer, wherein each key structure is pressable and wherein the corresponding contact element of each key structure is triggerable with contact to signal the processor; and
a panel provided over the display area and extending between the key structures and the electrical contact layer, wherein the panel is structured so that, when the computing device is operational, (i) a user contact with a region of the panel that overlies the display area is detectable by the display component to signal the processor, and (ii) pressure on any key structure is sufficient to move at least a portion of the panel inward into the corresponding contact element in order to trigger the contact element into signaling the processor.

2. The computing device of claim 1, wherein the panel is single-pieced and flat.

3. The computing device of claim 2, wherein the panel is formed from polyethylene terephthalate.

4. The computing device of claim 1, wherein the panel is single-pieced and flat, and wherein the panel includes a window that overlays the display area.

5. The computing device of claim 1, wherein the plurality of key structures include a translucent thickness, and wherein the panel includes an imprint that underlies at least some of the plurality of key structures.

6. The computing device of claim 1, wherein the plurality of key structures are provided as a single component that individually defines the plurality of structures with a variable thickness.

7. The computing device of claim 1, wherein at least some of the key structures of the keypad assembly define a keyboard.

8. The computing device of claim 7, wherein a subset of the at least some of the key structures that define the keyboard also define a number pad.

9. The computing device of claim 1, wherein the panel includes one or more regions having imprints, color and/or shading.

10. The computing device of claim 1, wherein the display component includes one or more resistive contact sensors that detect contact in the display area.

11. The computing device of claim 10, wherein the display component includes a separate panel provided to overlay the display area and underlie the panel that extends between the key structures and the electrical contact layer.

12. The computing device of claim 11, wherein the separate panel and the panel that extends between the key structures and the electrical contact layer are formed from a same material.

13. The computing device of claim 12, wherein the separate panel and the panel that extends between the key structures and the electrical contact layer are in contact.

14. The computing device of claim 1, wherein the panel is placed in contact with the display component and the electrical contact layer.

15. The computing device of claim 1, wherein each key structure is pressable by being movable inward.

16. The computing device of claim 1, wherein each key structure is pressable by being deformable.

17. A computing device comprising:
a processor;
a display component having a display area;
a keypad assembly comprising a plurality of key structures, each of the key structures being aligned over a corresponding contact element provided on an electrical contact layer, wherein each key structure is pressable and wherein the corresponding contact element of each key structure is triggerable with contact to signal the processor; and
a panel provided over the display area and extending between the key structures and the electrical contact layer, wherein the panel includes at least a translucent window that overlays the display area and is structured so that inward movement of any key structure is sufficient to move at least a portion of the panel inward into the corresponding contact element in order to trigger the contact element into signaling the processor.

18. The computing device of claim 17, wherein the panel is single-pieced and flat.

19. The computing device of claim 18, wherein the panel is formed from polyethylene terephthalate.

20. The computing device of claim 17, wherein each key structure is pressable by being movable inward.

21. The computing device of claim 17, wherein each key structure is pressable by being deformable.

22. A frontal assembly for a mobile computing device, the fontal assembly comprising:
a display component having a display area;
a keypad assembly comprising a plurality of key structures, each of the key structures being aligned over a corresponding contact element provided on an underlying electrical contact layer, wherein each key structure is pressable; and
a panel provided over the display area and extending between the key structures and the electrical contact layer, wherein the panel is structured to be in contact with the display area and with the plurality of key structures, so that movement of any key structure is sufficient to move at least a portion of the panel inward into the corresponding contact element.

23. The frontal assembly of claim 22, wherein the panel includes one or more regions having imprints, color and/or shading.

24. The frontal assembly of claim 22, wherein the keypad assembly includes a sheet key that defines at least a keyboard.

25. The frontal assembly of claim 22, wherein at least some of the plurality of key structures are translucent.
